(19) United States
(12) Patent Application Publication
(10) Pub. No.: US 2019/0129223 A1
(43) Pub. Date: May 2, 2019

(54) IN-CELL TOUCH PANEL AND ELECTRONIC DEVICE

(71) Applicant: WUHAN CHINA STAR OPTOELECTRONICS TECHNOLOGY CO., LTD., Wuhan, Hubei (CN)

(72) Inventors: Yao-li HUANG, Shenzhen, Guangdong (CN); Hongsen ZHANG, Shenzhen, Guangdong (CN)

(21) Appl. No.: 15/744,378

(22) PCT Filed: Nov. 24, 2017
(86) PCT No.: PCT/CN2017/112869

§ 371 Date: Jan. 12, 2018

(30) Foreign Application Priority Data
Oct. 30, 2017 (CN) 201711052691.X

(51) Int. Cl. G02F 1/1339; G02F 1/1333; G02F 1/1362

(52) U.S. Cl. CPC G02F 1/13394; G02F 1/134363; G02F 1/136286; G02F 1/13338

(57) ABSTRACT

An in-cell touch display panel and an electronic device having the in-cell touch display panel are provided. The in-cell touch display panel comprises a TFT substrate, a CF substrate opposite to the TFT substrate, and a liquid crystal layer, a main supporting column and a secondary supporting column sandwiched between the TFT substrate and the CF substrate; the TFT substrate comprises a metal wiring layer provided on in interlayer insulating layer and a first protection layer covering the metal wiring layer; the main supporting column is connected between the first protection layer and the CF substrate, the first protection layer is sandwiched between the main supporting column and the metal wiring layer, the main supporting column stands correspondingly on the metal wiring layer, and the secondary supporting column is provided on the CF substrate; the secondary supporting column and the main supporting column have the same thickness.

### RELATED APPLICATIONS

The present application is a National Phase of International Application Number PCT/CN2017/112869, filed Nov. 24, 2017, and claims the priority of China Application No. 201711052691.X, filed Oct. 30, 2017.

### FIELD OF THE DISCLOSURE

The disclosure relates to a touch display technical filed, and more particularly to an in-cell touch panel and an electronic device having the in-cell touch panel.

### BACKGROUND

As the development of the touch display technic, more and more in-cell touch display panels are applied for the electronic display device such as cell phone. Since the in-cell touch display panel integrates the touch and display functions, namely, both the touch circuit and the display circuit are designed on the thin film transistor (TFT) array substrate (also called TFT substrate), it facilitates increasing penetration and makes the electronic device thinner, such as cell phone.

The in-cell touch display panel includes self-capacitance type and mutual-capacitance type. For achieving integrating the touch and display functions, some process should be carried out on the array circuits of the TFT substrate to the two types, on the basis of the non-touch display panel. The in-cell touch panel is integrated to the TFT substrate. Because the touch panel (TP) sensor needs touch wires, a metal layer and an insulating layer should be formed on the basis of the traditional TFT process for isolation and vias, thereby realizing the connection between the driving die and the TP sensor.

Referring to FIG. 1, a traditional in-cell touch display panel includes a TFT substrate 100, a color filter (CF) substrate 200 provided opposite to the TFT substrate 100, and a liquid crystal layer 300 sandwiched between the TFT substrate 100 and the CF substrate 200. The TFT substrate 100 includes an even layer 101 (conventional substrate layer, gate layer, active layer, source/drain layer and multiple insulating layers which are omitted herein are provided under the even layer), a common electrode layer 102 provided on the even layer 101, an interlayer insulating layer 103 covering the common electrode layer 102, a metal wiring layer 104 provided on the interlayer insulating layer 103, a protection layer 105 covering the metal wiring layer 104, and a pixel electrode layer 106 provided on the protection layer 105. A main supporting column 205 and a secondary supporting column 206 for protecting from compressing by the in-cell touch panel are provided on the CF substrate 200. A gape between the main supporting column 205 and the secondary supporting column 206 is designed to be 0.3 um˜0.5 um. Processes such as coating, exposure, development and stripping should be carried out separately twice when making the main supporting column 205 and secondary supporting column 206, so as to form two supporting columns with different thickness. Therefore, the process in manufacturing the in-cell touch panel are more complex and have higher costs.

### SUMMARY

A technical problem to be solved by the disclosure is to provide an in-cell touch display panel and an electronic device including the in-cell touch display panel.

An in-cell touch display panel, comprising a TFT substrate, a CF substrate provided opposite to the TFT substrate, and a liquid crystal layer, a main supporting column and a secondary supporting column sandwiched between the TFT substrate and the CF substrate, the TFT substrate comprising an even layer, a common electrode layer provided on the even layer, an interlayer insulating layer covering the common electrode layer, a metal wiring layer provided on the interlayer insulating layer, and a first protection layer covering the metal wiring layer; wherein the main supporting column is connected between the first protection layer and the CF substrate, the first protection layer is sandwiched between the main supporting column and the metal wiring layer, the main supporting column stands correspondingly on the metal wiring layer, and the secondary supporting column is provided on the CF substrate adjacent to the liquid crystal layer; and wherein the secondary supporting column and the main supporting column have the same thickness.

In an embodiment, the metal wiring layer comprises a first surface and a second surface provided opposite to each other, the first protection layer is attached to the first surface, the second surface is attached to the interlayer insulating layer, and the main supporting column stands correspondingly on the first surface.

In an embodiment, the even layer is provided to extend along a first dash line, the main supporting column and the metal wiring layer are arranged along a second dash line perpendicular to the first dash line.

In an embodiment, the CF substrate comprises a second protection layer, a color film layer and a substrate layer, wherein the color fil layer is sandwiched between the second protection layer and the substrate layer, the second protection layer is provided adjacent to the liquid crystal layer, the main supporting column is connected between the first protection layer and the second protection layer, and the secondary supporting column is provided on the second protection layer.

In an embodiment, the metal wiring layer has a thickness of 0.3 um˜0.4 um

In an embodiment, wherein the metal wiring layer is made of copper, silver or aluminum.

In an embodiment, the in-cell touch display panel further includes a pixel electrode layer provided on the first protection layer.

In an embodiment, the common electrode layer and the pixel electrode layer are made of ITO.

In an embodiment, the first protection layer is made of silicon oxide or silicon nitride.

An electronic device, comprising a case and an in-cell touch display panel provided on the case, wherein the in-cell touch display panel comprises a TFT substrate, a CF substrate provided opposite to the TFT substrate, and a liquid crystal layer, a main supporting column and a secondary supporting column sandwiched between the TFT substrate and the CF substrate, the TFT substrate comprising an even layer, a common electrode layer provided on the even layer, an interlayer insulating layer covering the common electrode layer, a metal wiring layer provided on the interlayer insulating layer, and a first protection layer covering the metal wiring layer; wherein the main supporting column is connected between the first protection layer and the CF substrate, the first protection layer is sandwiched between the main supporting column and the metal wiring layer, the main supporting column stands correspondingly on the metal wiring layer, and the secondary supporting column is provided on the CF substrate adjacent to the liquid crystal layer; and wherein the secondary supporting column and the main supporting column have the same thickness.

In an embodiment, the electronic device is a LCD TV, a smart phone, a digital camera, a tablet, or a wearable watch.

In embodiments of the in-cell touch display panel and the electronic device having the in-cell touch display panel of the disclosure, the main supporting column stands correspondingly on the metal wiring layer, and the main supporting column have the same thickness as the second supporting column such that there is no exist gape there between. Therefore, it needs to form supporting columns having the same thickness, that is, only one ordinary mask and one process such as coating, exposure, development and stripping are necessary when manufacturing the main supporting column and the secondary supporting column, so as to simplify the process of the in-cell touch panel and reduce the manufacturing cost.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a cross-sectional view of a traditional in-cell touch display panel;

FIG. 2 is a cross-sectional view of an in-cell touch display panel according to an embodiment of the disclosure; and

FIG. 3 is a schematic diagram of an electronic device.

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

Referring to FIG. 2, an in-cell touch display panel 1 includes a TFT substrate 10, a CF substrate 20 provided opposite to the TFT substrate 10, and a liquid crystal layer 30 sandwiched between the TFT substrate 10 and the CF substrate 20.

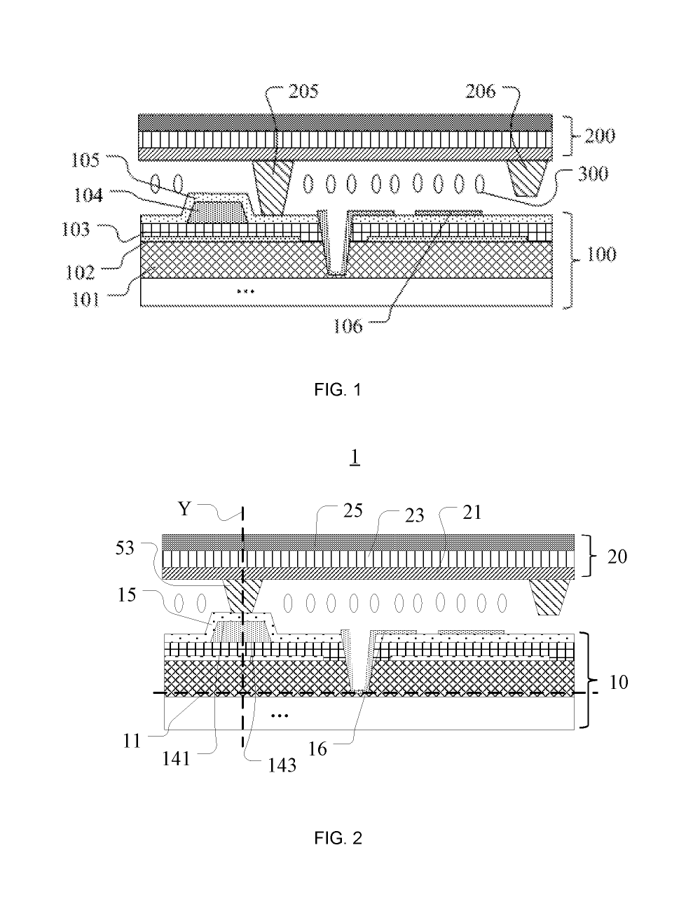

The TFT substrate 10 includes an even layer 11 (the conventional substrate layer, gate layer, active layer, source/drain layer and multiple insulating layers which are omitted herein are provided under the even layer), a common electrode layer 12 provided on the even layer 11, an interlayer insulating layer 13 covering the common electrode layer 12, a metal wiring layer 14 provided on the interlayer insulating layer 13, a first protection layer 15 covering the metal wiring layer 14, and a pixel electrode layer 16 provided on the first protection layer 15. In an embodiment illustrated in FIG. 1, the common electrode layer 12 and the pixel electrode layer 16 can be made of Indium Tin Oxide(ITO). The metal wiring layer 14 has a thickness with 0.3 um˜0.4 um. The metal wiring layer 14 can be made of a material with well conductive performance such as copper (Cu), silver (Ag), aluminum (Al). The first protection layer 15 can be made of inorganic materials such as silicon oxide, silicon nitride, and so forth.

The CF substrate 20 includes a second protection layer 21, color film layer 23 and substrate layer 25. The color film layer 23 is sandwiched between the second protection layer 21 and the substrate layer 25. The second protection layer 21 is provided adjacent to the liquid crystal layer 30.

The in-cell touch display panel 1 further includes a main supporting column 53 and a secondary supporting column 55. The main supporting column 53 supports between the CF substrate 20 and the TFT substrate 10 so as to provide the cell gap. Specifically, the main supporting column 53 is connected between the first protection layer 15 and the second protection layer 21. The first protection layer 15 is sandwiched between the main supporting column 53 and the metal wiring layer 14. The main supporting column 53 stands correspondingly at the metal wiring layer 14.

Moreover, the metal wiring layer 14 includes a first surface 141 and a second surface 143 provided opposite to each other. The second surface 143 is attached to the interlayer insulating layer 13, and the first protection layer 15 id attached to the first surface 141. The main supporting column 53 stands correspondingly at the first surface 141. The first protection layer 15 is sandwiched between the first surface 141 and the main supporting column 53.

Furthermore, the even layer 11 is provided to extend along a first dash line X, the main supporting column 53 and the metal wiring layer 14 are arranged along a second dash line Y perpendicular to the first dash line X. In other words, the main supporting column 53, the first protection layer 15, the first surface 141, and the second surface 143 are arranged to stack in order along the second dash line Y. In addition, the first surface 141 is substantially perpendicular to the second dash line Y, and the second surface 143 is substantially perpendicular to the second dash line Y.

It should be note that, the first surface 141 and the second dash line Y are not limited to substantially perpendicular to each other, the second surface 143 and the second dash line Y are not limited to substantially perpendicular to each other. The main supporting column 53 stands correspondingly above the metal wiring layer 14.

The secondary supporting column 55 is provided on the second protection layer 21 and between the second protection layer 21 and the first protection layer 15. The secondary supporting column 55 is provided for preventing from the compression by the in-cell touch panel 1. The secondary supporting column 55 is provided separately from the metal wiring layer 14, that is, the secondary supporting column 55 avoids standing at the metal wiring layer 14.

The main supporting column 53 and the secondary supporting column 55 have the same thickness. Moreover, the main supporting column 53 and the secondary supporting column 55 have the same structure.

For the traditional in-cell touch display panel, since agape between the main supporting column and the secondary supporting column needs to be designed to 0.3 um˜0.5 um, processes such as coating, exposure, development and stripping should be carried out separately twice with the ordinary mask during the manufacture.

By contrast, in the disclosure, the main supporting column 53 stands on the metal wiring layer 14, and the main supporting column 53 have the same thickness as the secondary supporting column 55 with no gape there between. Therefore, it needs to form supporting columns having the same thickness, that is, only one ordinary mask and one process such as coating, exposure, development and stripping are necessary when manufacturing the main supporting column 53 and the secondary supporting column 55, so as to simplify the process of the in-cell touch panel 1 and reduce the manufacturing cost. In addition, since the main supporting column 53 stands on the metal wiring layer 14 and have the same thickness as the secondary supporting column 55, it further ensures the same supporting height everywhere and the uniform thickness of the liquid crystal layer 30, thereby facilitating increasing the display performance of the in-cell touch display panel 1.

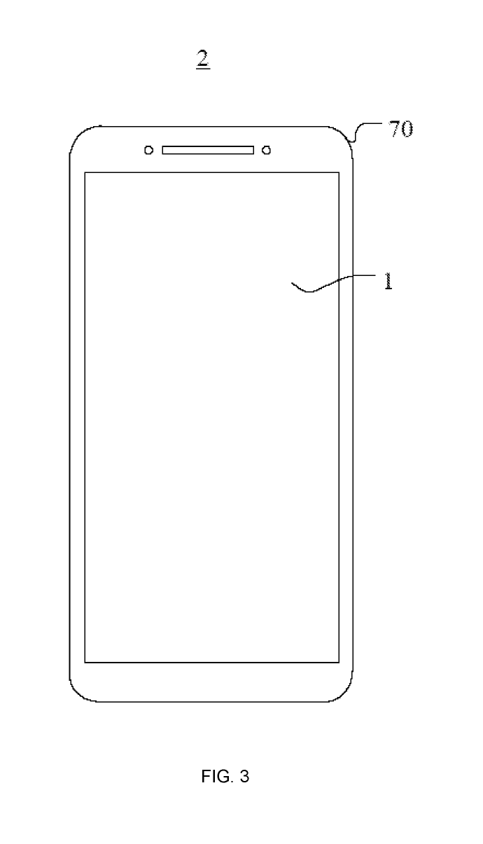

Referring to FIG. 3, an electronic device 2 is also provided in the disclosure. The electronic device 2 includes a case 70 and an in-cell touch display panel 1 provided in the case 70. The electronic device 2 can be a device with touch display function such as but not limited to a LCD TV, a smart phone, a digital camera, a tablet, and a wearable watch.

The foregoing contents are detailed description of the disclosure in conjunction with specific preferred embodiments and concrete embodiments of the disclosure are not limited to this description. For the person skilled in the art of the disclosure, without departing from the concept of the disclosure, simple deductions or substitutions can be made and should be included in the protection scope of the application.

What is claimed is:

1. An in-cell touch display panel, comprising a TFT substrate, a CF substrate provided opposite to the TFT substrate, and a liquid crystal layer, a main supporting column and a secondary supporting column sandwiched between the TFT substrate and the CF substrate, the TFT substrate comprising a planarization layer, a common electrode layer provided on the planarization layer, an interlayer insulating layer covering the common electrode layer, a metal wiring layer provided on the interlayer insulating layer, and a first protection layer covering the metal wiring layer;
wherein the main supporting column is connected between the first protection layer and the CF substrate, the first protection layer is sandwiched between the main supporting column and the metal wiring layer, the main supporting column stands correspondingly on the metal wiring layer, and the secondary supporting column is provided on the CF substrate adjacent to the liquid crystal layer; and
wherein the secondary supporting column and the main supporting column have the same thickness.

2. The in-cell touch display panel according to claim 1, wherein the metal wiring layer comprises a first surface and a second surface provided opposite to each other, the first protection layer is attached to the first surface, the second surface is attached to the interlayer insulating layer, and the main supporting column stands correspondingly on the first surface.

3. The in-cell touch display panel according to claim 1, wherein the planarization layer extends along a first dash line, the main supporting column and the metal wiring layer are arranged along a second dash line perpendicular to the first dash line.

4. The in-cell touch display panel according to claim 1, wherein the CF substrate comprises a second protection layer, a color film layer and a substrate layer, wherein the color fil layer is sandwiched between the second protection layer and the substrate layer, the second protection layer is provided adjacent to the liquid crystal layer, the main supporting column is connected between the first protection layer and the second protection layer, and the secondary supporting column is provided on the second protection layer.

5. The in-cell touch display panel according to claim 1, wherein the metal wiring layer has a thickness of 0.3 um˜0.4 um.

6. The in-cell touch display panel according to claim 1, wherein the metal wiring layer is made of copper, silver or aluminum.

7. The in-cell touch display panel according to claim 1, wherein the in-cell touch display panel further comprises a pixel electrode layer provided on the first protection layer.

8. The in-cell touch display panel according to claim 7, wherein the common electrode layer and the pixel electrode layer are made of ITO.

9. The in-cell touch display panel according to claim 1, wherein the first protection layer is made of silicon oxide or silicon nitride.

10. An electronic device, comprising a case and an in-cell touch display panel provided on the case, wherein the in-cell touch display panel comprises a TFT substrate, a CF substrate provided opposite to the TFT substrate, and a liquid crystal layer, a main supporting column and a secondary supporting column sandwiched between the TFT substrate and the CF substrate; the TFT substrate comprises a planarization layer, a common electrode layer provided on the planarization layer, an interlayer insulating layer covering the common electrode layer, a metal wiring layer provided on the interlayer insulating layer, and a first protection layer covering the metal wiring layer;
wherein the main supporting column is connected between the first protection layer and the CF substrate, the first protection layer is sandwiched between the main supporting column and the metal wiring layer, the main supporting column stands correspondingly on the metal wiring layer, and the secondary supporting column is provided on the CF substrate adjacent to the liquid crystal layer; and
wherein the secondary supporting column and the main supporting column have the same thickness.

11. The electronic device according to claim 10, wherein the electronic device is a LCD TV, a smart phone, a digital camera, a tablet, or a wearable watch.

12. The electronic device according to claim 10, wherein the metal wiring layer comprises a first surface and a second surface provided opposite to each other, the first protection layer is attached to the first surface, the second surface is attached to the interlayer insulating layer, and the main supporting column stands correspondingly on the first surface.

13. The electronic device according to claim 10, wherein the planarization layer is provided to extend along a first dash line, the main supporting column and the metal wiring layer are arranged along a second dash line perpendicular to the first dash line.

14. The electronic device according to claim 10, wherein the CF substrate comprises a second protection layer, a color film layer and a substrate layer, wherein the color fil layer is sandwiched between the second protection layer and the substrate layer, the second protection layer is provided adjacent to the liquid crystal layer, the main supporting column is connected between the first protection layer and the second protection layer, and the secondary supporting column is provided on the second protection layer.

15. The electronic device according to claim 10, wherein the metal wiring layer has a thickness of 0.3 um˜0.4 um.

16. The electronic device according to claim 10, wherein the metal wiring layer is made of copper, silver or aluminum.

17. The electronic device according to claim 10, wherein the in-cell touch display panel further comprises a pixel electrode layer, the pixel electrode layer is provided on the first protection layer and adjacent to the liquid crystal layer.

18. The electronic device according to claim 17, wherein the common electrode layer and the pixel electrode layer are made of ITO.

19. The electronic device according to claim 10, wherein the first protection layer is made of silicon oxide or silicon nitride.
